(19) United States
(12) Patent Application Publication
(10) Pub. No.: US 2005/0230036 A1
(43) Pub. Date: Oct. 20, 2005

(54) Lightweight airfoil and method of manufacturing same

(76) Inventor: John Lampl, Repulse Bay (HK)

Correspondence Address: MCDERMOTT WILL & EMERY LLP, 600 13TH STREET, N.W., WASHINGTON, DC, 20005-3096, US

(21) Appl. No.: 10/825,218

(22) Filed: Apr. 16, 2004

(51) Int. Cl. B64C 3/44; B32B 31/00

(52) U.S. Cl. 156/250; 244/123.1; 156/263

(57) ABSTRACT

A lightweight airfoil having a skin over a frame, and manufacturing process therefore, in which the airfoil is formed by coring a sheet of support material, attaching skin material to the cored sheet of support material to form a laminate, and defining an outer portion of the airfoil from the laminate, and then defining the frame in the support material, for example, by compressing the support material proximate the frame. The airfoil may be defined by trimming excess material from the laminate proximate an outer portion of the frame. A single sheet of support material, such as expanded polystyrene, can span in each of these steps.

### TECHNICAL FIELD

The invention relates generally to airfoils and, more specifically, a method of manufacturing a lightweight airfoil.

### BACKGROUND ART

One of the biggest issues confronting any designer of aircraft, whether the aircraft is a jumbo jet or miniature model airplane, involves minimizing the weight of the aircraft. When the weight of the aircraft is decreased, the amount of lift needed to make the aircraft fly is reduced, and this allows the aircraft designer additional flexibility in designing the characteristics of the aircraft. For example, when the required lift is reduced, the designer can reduce the size of the propulsion source. Additionally, by reducing the required lift, the designer can reduce the relative velocity the aircraft needs to achieve to obtain lift since lift is a function of velocity.

To produce a toy or model aircraft capable of being flown indoors (i.e., in a relatively small volume), the velocity the aircraft requires to achieve lift needs to be reduced in order to fly the aircraft safely. Otherwise, by the time the aircraft is in flight, the aircraft will have to be continuously turning to prevent the aircraft from running into a wall. Thus, to produce an aircraft capable of flying indoors, the issue of reducing the weight of the aircraft needs to be revisited.

With today's powered hobby and toy aircraft, a significant portion of the weight of the aircraft is usually found in the wings of the aircraft. These wings are typically formed from expanded polystyrene sheet (EPS). Besides being relatively lightweight, EPS also has sufficient strength to maintain a shape of an airfoil, including camber and dihedral. EPS is also a popular material for large volume manufacturing as the EPS can be provided to a manufacturer in large rolls.

To form the wings, a continuous roll of EPS is fed through a heat press-form apparatus. The wings are formed in situ from the EPS, and are either fed directly into a die cutter or the sheets are cut into manageable predetermined lengths that are then placed into a multiple die cut form. The resulting product is a die-cut formed EPS wing, which constitutes the finished wing.

The area to weight ratio (in²/gram) of a conventionally-formed EPS wing using 4 millimeter thick EPS is around 9.4 in²/gram. However, an EPS wing formed by the conventional process is still too heavy to be used for an indoor aircraft. There is, therefore, a need for an improved method of manufacturing an airfoil wing that reduces the overall weight of the wing to enable an aircraft using this wing to be flown at very low speeds. In addition, the method of manufacturing should provide a wing having a strength comparable to an EPS wing.

A significant challenge to the success of an airfoil design also lies within its cost to manufacture. An airfoil should, in addition to the aforementioned performance-based needs, also be producible in a lost cost, high-volume process.

### SUMMARY

Disclosed is a process for forming a lightweight airfoil having a skin over a frame. The process includes defining the frame in a support material by compressing the support material proximate the frame. The sheet of support material is then cored to remove certain portions of the support material within the frame. After coring, skin material is attached to the cored sheet of support material to form a laminate. An outer portion of the airfoil is then defined from the laminate, which involves trimming excess material from the laminate proximate an outer portion of the frame. A single sheet of support material can span each of these processes, and the support material can be expanded polystyrene sheet. Through use of this process, an airfoil having an area to weight ratio of better than 30 in²/gram can be achieved.

Additional advantages will become readily apparent to those skilled in the art from the following detailed description, wherein only an exemplary embodiment of the present invention is shown and described, simply by way of illustration of the best mode contemplated for carrying out the present invention. As will be realized, the concepts described herein are capable of other and different embodiments, and its several details are capable of modifications in various obvious respects, all without departing from the invention. Accordingly, the drawings and description are to be regarded as illustrative in nature, and not as restrictive.

### BRIEF DESCRIPTION OF THE DRAWINGS

Reference is made to the attached drawings, wherein elements having the same reference numeral designations represent like elements throughout, and wherein:

FIGS. 1A and 1B are respective side and top schematic views of a system for manufacturing an airfoil according to the invention; and

FIGS. 2A-6A and 2B-6C are respective plan and cross-sectional views of an airfoil being formed according to the invention.

### DETAILED DESCRIPTION OF THE INVENTION

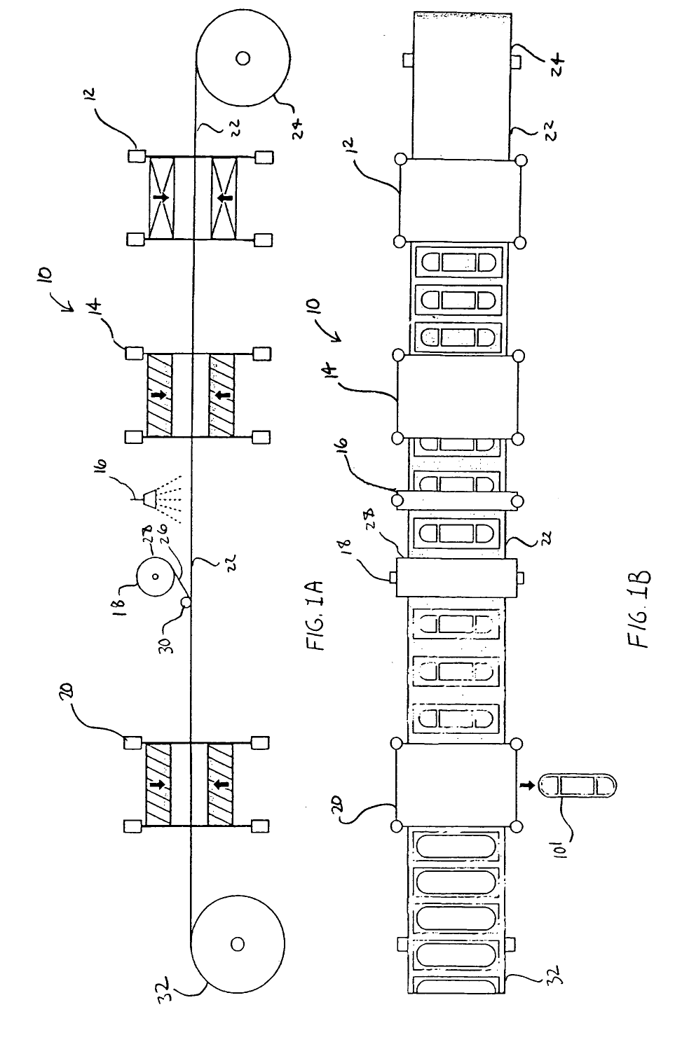

A novel manufacturing system 10 for manufacturing an airfoil described herein is illustrated in FIGS. 1A and 1B. The manufacturing system 10 includes a forming mold 12, a coring die cutter 14, an adhesive applicator 16, a laminator 18, and a trim die cutter 20. To begin the process, a sheet of support material 22 for the airfoil enters the forming mold 12 of the manufacturing system 10. Each sheet of support material 22 can be sufficient to supply only a single support frame for an airfoil, or as in a present aspect of the current method of manufacturing an airfoil, the sheet of support material 22 can be used for multiple support frames for multiple airfoils. Although not necessary, the sheet of support material 22 can be supplied to the manufacturing system 10 from a roll of support material 24.

Upon entering the forming mold 12, an initial outline of the frame for the airfoil is defined or imprinted into the sheet of support material 22. The type of forming mold 12 used for this operation can be dependent upon the type of material from which the support frame is formed, and the selection of a particular forming mold for a particular material would be readily apparent to one skilled in the art. In a present aspect of the manufacturing system 10, the forming mold 12 is a heat press forming mold.

After the initial outline of the support frame for the airfoil is created in the sheet of support material 22, the sheet of support material 22 is introduced into the coring die cutter 14 to remove excess material that is present within the support frame for the airfoil. Although in a current aspect of the manufacturing system 10, a single coring die cutter 22 is employed to remove three separate sections from the sheet of support material 22, alternatively, multiple coring die cutters 14 can be employed. The overall weight of the airfoil is reduced at this step as a result of removing the material within the support frame of the airfoil. Although shown in the figures as being performed in separate steps, the steps of creating the initial outline of the support frame and removing of the excess material from within the support frame can be combined.

Once the outline of the support frame for the airfoil has been created and the excess material from within the support frame removed, a sheet of skin material 26 is attached to the sheet of support material 22. Each sheet of skin material 26 can be sufficient in size to attach to only a single support frame for an airfoil, or as in a present aspect of the current method of manufacturing an airfoil, a single larger sheet of skin material 26 can be used to attach to multiple support frames for multiple airfoils. Although not necessary, the sheet of skin material 26 can be supplied to the manufacturing system 10 from a roll 28 of skin material 26.

Depending upon the support material 22 and the skin material 26, one skilled in the art will recognize that many different techniques can be employed to attach the skin material to the support material, and the present process of manufacturing an airfoil is not limited as to a particular technique. In a current aspect of the present process of manufacturing an airfoil, the sheet of skin material 26 is attached to the sheet of support material 22 using an adhesive. Any technique of applying the adhesive to the skin material and the support material may be used. For example, the adhesive may be pre-applied to the skin material. Alternatively, the adhesive may be sprayed, rolled, heat sealed, etc., onto one or both of the skin material and the support material immediately prior the skin material and the support material being jointed.

In a current aspect of the present process of manufacturing an airfoil, the adhesive is sprayed onto the sheet of support material 22 using an adhesive applicator 16. Once the adhesive is applied to the sheet of support material 22, a laminator 18 is used to attach the sheet of skin material 26 to the sheet of support material 22 to form a laminate of the two materials. Although not limited to a particular apparatus for adhering the sheet of skin material 26 to the sheet of support material 22, in a current aspect of the manufacturing system 10, the laminator 18 includes a roller 30 that presses the sheet of skin material 26 onto the adhesive-covered sheet of support material 22.

Upon attaching the sheet of skin material 26 to the sheet of support material 22, the laminate of skin material and support material is introduced into the trim die cutter 14 to define an outer portion of the airfoil. In so doing, the airfoil can be separated from the excess material that is present around the outer portion of the airfoil. Once separated from the laminate sheet of skin material and support material, the support frame is now covered with the skin material to form the airfoil. The remaining laminate sheet of skin material and support material can then be rolled into a waste roll 32.

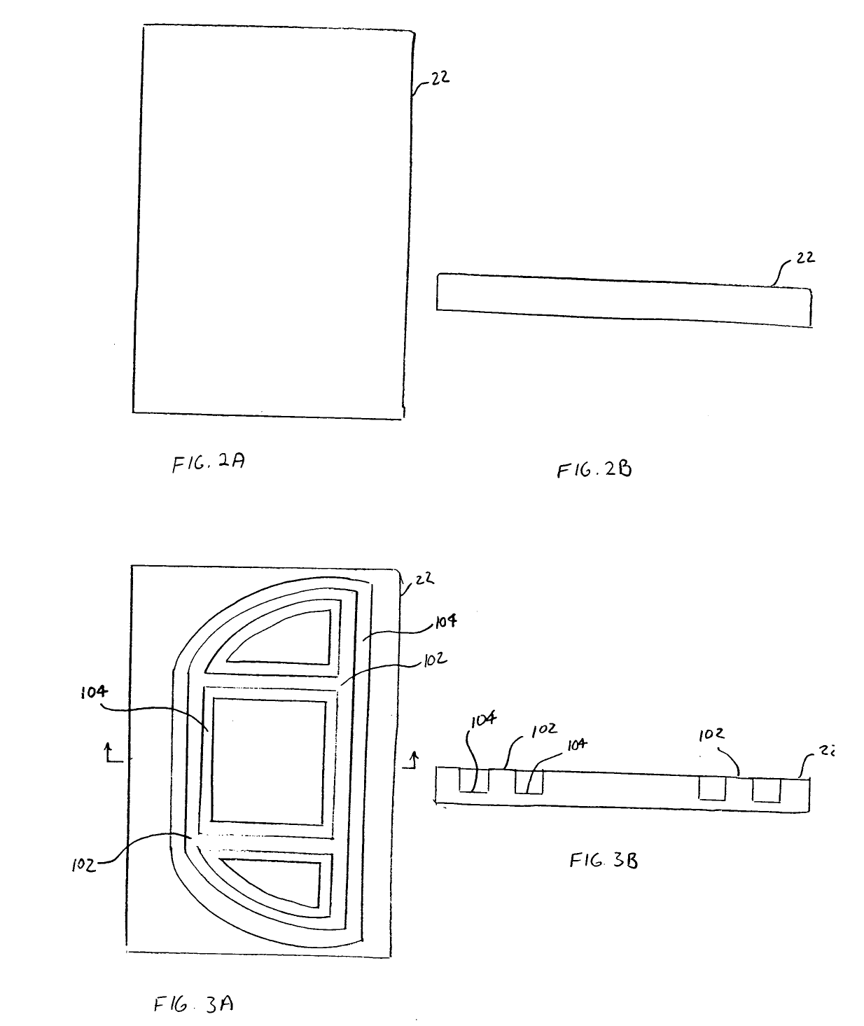

The airfoil 100, as it is formed through the manufacturing process, is illustrated in FIGS. 2A-B through 6A-B. In FIGS. 2A-B, the support material 22 has a generally constant width across its cross-section prior to the molding step. The molding process, as illustrated in FIGS. 3A-B, creates impressions 104 in the support material 22. These impressions 104 surround and define the frame 102 of the airfoil 100. Although not necessarily limited in this manner, all the impressions 104 are formed in a single major surface of the support material 22.

The coring process, as illustrated in FIGS. 4A-B, removes cores 106 of the support material 22 within the frame 102 of the airfoil 100. After the coring process, the ratio of an area included within the outer portion of the frame to the area of the frame itself can be between about 0.50 to about 0.10. In certain aspects, the ratio can be less than 0.05. With a ratio approaching 0.50, the frame will retain considerable strength, yet a reduction of weight of at least 50% can still be realized. With the ratio approaching 0.05, a weight reduction for the frame of at least 95% can be realized.

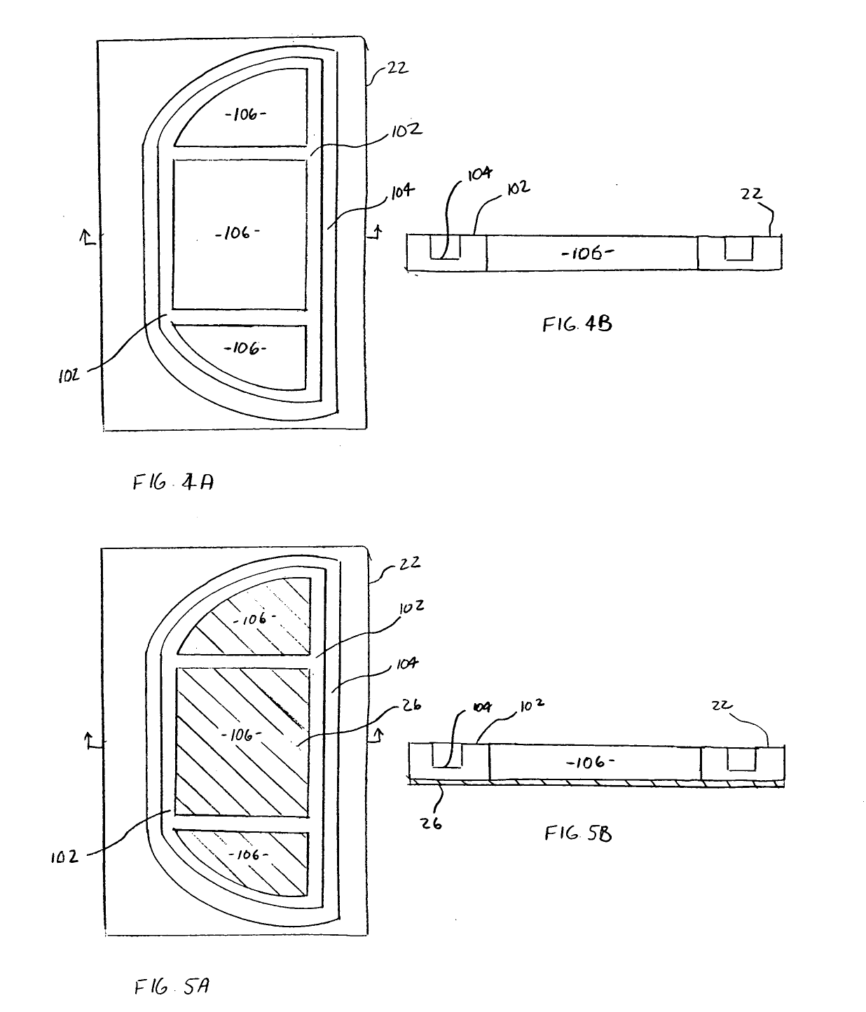

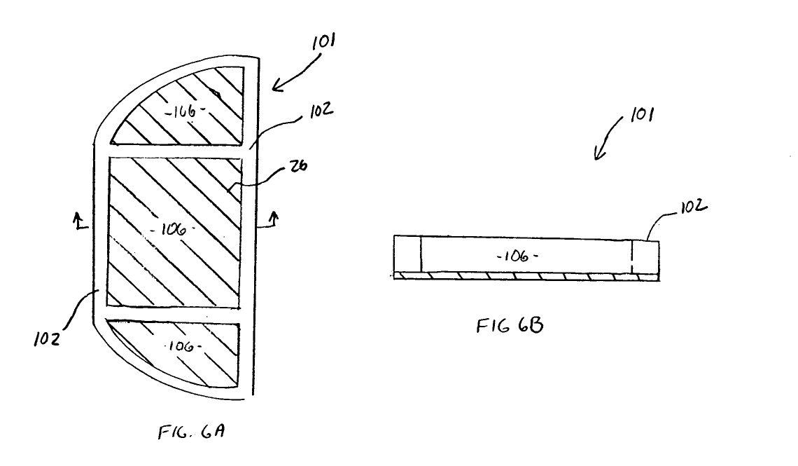

FIGS. 5A-B illustrate the laminate of the support material 22 and the skin material 26. The process of forming the airfoil 100 is not limited as to which major surface of the support material 22 the skin material 26 is attached. However, in a current aspect, the skin material 26 is attached to the major surface of the support material 22 that does not include the impressions 104. By placing the skin material 26 on the flat side of the support material 22, in contrast to placing the skin material 26 on the contoured side of the support material 22, the skin material 26 can better adhere to the support material. In FIGS. 6A-B, the support material 22 and the skin material 26 surrounding the outer portion of the frame 104 are removed, leaving the airfoil 101, which includes the frame 102 covered by the skin material 26.

The support material 22 is formed from a material that is strong, yet lightweight. The support material 22 is also formed from a material that can be easily cut with a press, and any material capable of meeting this characteristics may be used for the support material 22. In a current aspect, the support material 22 can also be available in long, rollable sheets. Examples of materials having these characteristics include Mylar, made by Dupont, biaxial oriented polypropylene (BOPP), and ethylene vinyl acetate (EVA). In a current aspect of the method of manufacturing an airfoil 101, the support material 22 is formed from expanded polystyrene sheet (EPS). The EPS support material 22 may have a thickness range of about 2.0 mm to about 8.0 mm and a density range of about 120 grams/m² to about 280 grams/m² at a 2.0 mm thickness. The thickness and density of the support material 22, however, may vary from these ranges.

The skin material 26 is formed from a material that is tear-resistant, strong and lightweight at a very thin thickness. The skin material 26 is also formed from a material that can be easily cut with a press, and any material capable of meeting this characteristics may be used for the skin material 26. In a current aspect, the skin material 26 can also be available in long, rollable sheets. Examples of materials having these characteristics include Mylar, BOPP, and EVA. In a current aspect of the method of manufacturing an airfoil 101, the skin material 26 is formed from BOPP. In a current aspect, the BOPP skin material 26 has a thickness range of about 6 microns to about 8 microns; however, the thickness the skin material 26 may vary from this range. For example, with a larger airfoil, a thickness of about 50 microns may be used.

By way of example, with an airfoil measuring about 16″ from tip to tip and about 6″ from leading edge to trailing edge, the airfoil has an area of about 90 in² and a weight of about 2.8 grams. These measurements yield an area to weight ratio of better than 32 in²/gram. In a current aspect, the airfoil 101 has a thickness of about 4 mm; however, the thickness the airfoil 101 may vary from this range. Through the use of this technique an airfoil having an area to weight ratio of 30 to 45 in²/gram or more can be realized.

The present concepts can be practiced by employing conventional materials, methodology and equipment. Accordingly, the details of such materials, equipment and methodology are not set forth herein in detail. In the previous descriptions, numerous specific details are set forth, such as specific materials, structures, chemicals, processes, etc., in order to provide a thorough understanding. However, it should be recognized that the concepts outlined above can be practiced without resorting to the details specifically set forth. In other instances, well known processing structures have not been described in detail, in order not to unnecessarily obscure the present concept. Only an exemplary aspect of the present invention and but a few examples of its versatility are shown and described in the present disclosure. It is to be understood that the present invention is capable of use in various other combinations and environments and is capable of changes or modifications within the scope of the inventive concept as expressed herein.

1. A method of manufacturing a lightweight airfoil having a frame and a skin over the frame, comprising the steps of:
coring a sheet of support material;
attaching a skin material to the cored sheet of support material to form a laminate sheet of skin material and support material; and
defining an outer portion of the airfoil from the laminate sheet.

2. The method according to claim 1, wherein the airfoil defining step includes trimming excess material from the laminate sheet proximate an outer portion of the frame.

3. The method according to claim 1, further comprising a step of defining the frame in the support material.

4. The method according to claim 3, wherein the frame defining step includes compressing the support material proximate the defined frame.

5. The method according to claim 4, wherein the compressing of the support material forms channels on only a first major side of the support material, and
the skin material is attached to the second major side of the support material.

6. The method according to claim 3, wherein the frame defining step precedes the coring step.

7. The method according to claim 1, wherein the coring step defines an inside portion of the frame.

8. The method according to claim 7, wherein the skin material is attached to the frame using an adhesive glue.

9. The method according to claim 8, further comprising the step of applying the adhesive to the cored sheet of support material prior to the attaching step.

10. The method according to claim 1, wherein the skin material includes biaxial oriented polypropylene.

11. The method according to claim 1, wherein the support material includes expanded polystyrene sheet.

12. The method according to claim 1, wherein a single sheet of support material extends from said coring step to said airfoil defining step.

13. The method according to claim 1, wherein the airfoil has a thickness of about 2.0 mm to about 8.0 mm.

14. The method according to claim 13, wherein the airfoil has an area to weight ratio of 30 in²/gram or more.

15. The method according to claim 1, wherein the airfoil has an area to weight ratio of 30 in²/gram or more.

16. The method according to claim 1, wherein the skin material is rolled onto the support material to form the laminate sheet.

17. The method according to claim 1, wherein the airfoil defining step separates the airfoil from the laminate sheet.

18. The method according to claim 1, wherein a ratio of an area of the frame to an area defined by the frame is less than 0.10.

19. The method according to claim 1, wherein a ratio of an area of the frame to an area defined by the frame is less than 0.05.

20. A method of manufacturing a lightweight airfoil having a frame and a skin over the frame, comprising the steps of:
defining the frame by compressing the support material proximate the frame;
coring a sheet of support material;
applying an adhesive to at least one of the skin material and the support material;
attaching a skin material to the cored sheet of support material using the adhesive to form a laminate sheet of skin material and support material; and
defining an outer portion of the airfoil from the laminate sheet, wherein a single sheet of support material extends from said coring step to said airfoil defining step.

21. A lightweight airfoil, comprising
a frame; and
a skin attached to the frame, wherein the airfoil has an area to weight ratio of 30 in²/gram or more.

22. The lightweight airfoil according to claim 21, wherein the frame is formed from a single sheet of expanded polystyrene.

23. The lightweight airfoil according to claim 22, wherein the skin includes biaxial oriented polypropylene.

24. The lightweight airfoil according to claim 21, wherein the frame has a thickness of about 2.0 mm to about 8.0 mm.

25. The lightweight airfoil according to claim 21, wherein the frame is attached to the skin with an adhesive glue.

26. The lightweight airfoil according to claim 21, wherein the frame is cored.

27. The lightweight airfoil according to claim 21, wherein the airfoil has an area to weight ratio of 30 in²/gram or more.

28. The lightweight airfoil according to claim 21, wherein a ratio of an area of the frame to an area defined by the frame is less than 0.10.

29. The lightweight airfoil according to claim 21, wherein a ratio of an area of the frame to an area defined by the frame is less than 0.05.

30. A lightweight airfoil, comprising
a cored frame; and
a skin attached to the frame with an adhesive, wherein the frame is formed from a single sheet of expanded polystyrene.

31. The lightweight airfoil according to claim 30, wherein the airfoil has an area to weight ratio of 20 in²/gram or more.

32. The lightweight airfoil according to claim 30, wherein the airfoil has an area to weight ratio of 30 in²/gram or more.

33. The lightweight airfoil according to claim 30, wherein a ratio of an area of the frame to an area defined by the frame is less than 0.10.

34. The lightweight airfoil according to claim 30, wherein a ratio of an area of the frame to an area defined by the frame is less than 0.05.

35. The lightweight airfoil according to claim 30, wherein the frame has a thickness of about 2.0 to about 8.0.
